(19) United States
(12) Patent Application Publication
(10) Pub. No.: US 2023/0349243 A1
(43) Pub. Date: Nov. 2, 2023

(54) TORQUE RING SELECTION

(71) Applicant: Nabors Drilling Technologies USA, Inc., Houston, TX (US)

(72) Inventors: Eric Couch, Crosby, TX (US); Julio Romero, Humble, TX (US); Bradley W. Riley, Waller, TX (US); John D. Polen, Dayton, TX (US); David Hasler, Houston, TX (US)

(21) Appl. No.: 18/309,424

(22) Filed: Apr. 28, 2023

Related U.S. Application Data
(60) Provisional application No. 63/363,721, filed on Apr. 28, 2022.

(51) Int. Cl. E21B 19/16; E21B 17/042

(52) U.S. Cl. CPC E21B 19/165; E21B 17/042; H04N 7/18

(57) ABSTRACT

A method for making up a tool joint in a casing string that can include operations of installing a first casing collar on a first end of a first casing segment, determining a first selection distance that is measured between a shoulder of the first end of the first casing segment and a shoulder of the first casing collar, and selecting a first torque ring based on the first selection distance.

### CROSS-REFERENCE TO RELATED APPLICATION(S)

This application claims priority under 35 U.S.C. § 119(e) to U.S. Provisional Application No. 63/363,721, entitled “TORQUE RING SELECTION,” by Eric COUCH et al., filed Apr. 28, 2022, which is assigned to the current assignee hereof and incorporated herein by reference in its entirety.

### FIELD OF THE DISCLOSURE

The present invention relates, in general, to the field of drilling and processing of wells. More particularly, present embodiments relate to a system and method for selecting torque rings when assembling a casing string during subterranean operations.

### BACKGROUND

When making up tool joints in a casing string, a torque ring may be used to fill a gap between two adjacent casing segments connected via a casing collar. The torque ring can provide improved torquing of the joint by improving the structural integrity of the tool joint by allowing pin to pin engagement of the adjacent casing segments. However, torque rings come in various lengths and diameters to accommodate the various casing connections. Selecting and installing the appropriate torque ring for making up a casing connection may be in the primary path of a subterranean operation being performed by a rig. Therefore, improvements in selecting and installing the appropriate torque rings are continually needed.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

One general aspect includes a method for building a casing string. The method can include installing a first casing collar on a first end of a first casing segment, determining a first selection distance, where the first selection distance is measured between a shoulder of the first end of the first casing segment and a shoulder of the first casing collar, and selecting a first torque ring based on the first selection distance. Other embodiments of this aspect include corresponding computer systems, apparatus, and computer programs recorded on one or more computer storage devices, each configured to perform the actions of the methods.

One general aspect includes a method for making up a tool joint in a casing string. The method also can include receiving a first casing segment at a rig, where the first casing segment may include a first casing collar installed to an end of the first casing segment thereby forming a box end of the first casing segment, determining a selection distance, where the selection distance is measured between a first shoulder of the first casing segment and a first shoulder of the first casing collar, where the first shoulder of the first casing segment is proximate the box end of the first casing segment and the first shoulder of the first casing collar is disposed on an opposite end of the first casing collar from a second shoulder of the first casing collar; and selecting a first torque ring based on the selection distance. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1 is a representative functional block diagram of a system that can be used to run a casing string into a wellbore, in accordance with certain embodiments;

FIG. 2 is a representative side view of a portion of a casing string extending above slips on a rig floor, in accordance with certain embodiments;

FIG. 3 is a representative functional block diagram of a rig controller from controlling rig equipment during subterranean operations, in accordance with certain embodiments;

FIG. 4A is a representative partial cross-sectional view of a casing collar attached to a casing segment with a selection guide that can be used to determine a desired torque ring for making up the tool joint, in accordance with certain embodiments;

FIG. 4B is a representative detailed partial cross-sectional view of the region 4B indicated in FIG. 4A, in accordance with certain embodiments;

FIG. 4C is a representative partial cross-sectional view of a casing collar attached to a casing segment with one or more sensors configured to determine a desired torque ring for making the tool joint, in accordance with certain embodiments;

FIG. 5 is a representative partial cross-sectional view of a casing collar attached to a casing segment with a desired torque ring installed in the casing collar, in accordance with certain embodiments;

FIG. 6A is a representative partial cross-sectional view of a casing collar attached to a casing segment with a desired torque ring installed in the casing collar and a second casing segment installed in the casing collar and abutting the torque ring, in accordance with certain embodiments;

FIG. 6B is a representative detailed partial cross-sectional view of the region 6B indicated in FIG. 6A, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

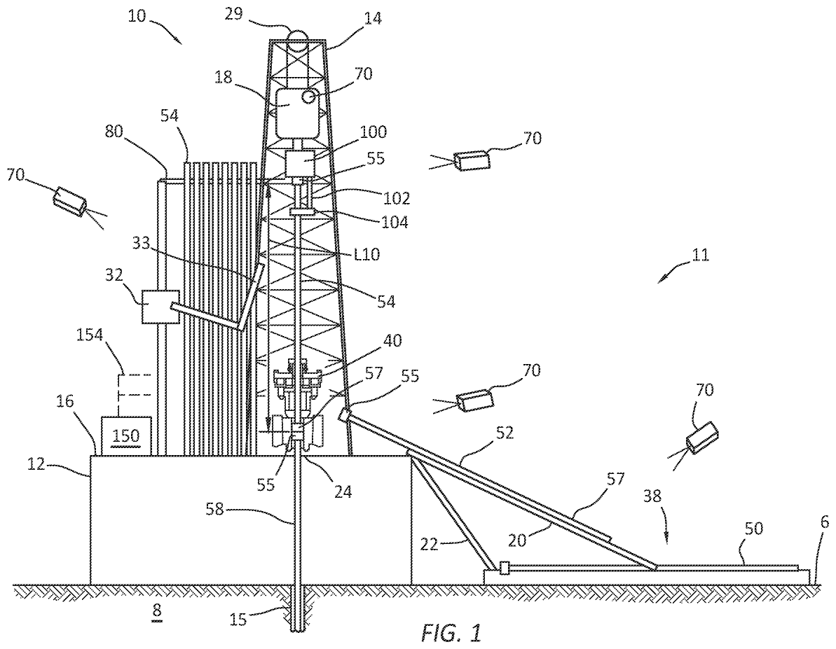

As used herein, “casing segment” refers to an elongated cylindrical tube and can include any of the casing segments manipulated around a rig 10, such as the casing segments shown in FIG. 1.

FIG. 1 is a representative functional block diagram of a rig 10 at a rig site 11 for managing casing segments to run a casing string 58 into or out of the wellbore 15 formed through the surface 6 and into the subterranean formation 8. The rig 10 can include a platform 12 with a derrick 14 extending from a rig floor 16. The derrick 14 can provide structural support for the top drive 18 and a crown block 29. The crown block 29 can be used to raise and lower the top drive 18. A casing running tool 100 can be coupled to the top drive 18 to facilitate moving casing segments from a catwalk 20 (or other pipe handler 30, 32, 34) to well center 24 for connection to a stump 60 (i.e., portion of casing string 58 protruding above the rig floor 16) at the well center 24.

For tripping in, the casing string 58 is run into the wellbore 15 by successively adding additional casing segments 54 to the top end (i.e., stump 60) of the casing string 58 to further extend the casing string 58 into the wellbore 15. Therefore, casing segments 50 positioned in a horizontal storage area 38 can be presented to the rig floor 16 via a catwalk 20 as it moves along a V-door ramp 22 (e.g., casing segment 52). It should be understood that any other tubular manipulation systems (such as pipe handler 32 with an articulating arm 33) can be used to deliver casing segments from a horizontal tubular storage area 38 or vertical tubular storage area 80 to the rig floor 16 so the top drive 18 (and possibly a casing running tool 100) can engage the casing segment 52 and move it to well center 24. Therefore, this disclosure is not limited to the catwalk type pipe handler.

Casing segments 50 may be delivered to a rig site 11 as a tubular with tapered external threads on each end of each casing segment unlike drilling tubulars, which can have a pin end with tapered external threads at one end and a box end with tapered internal threads at an opposite end. Each casing segment assembled into the casing string 58 can be threaded into a casing collar with an adjacent casing segment. The casing collar can have two sets of tapered internal threads that each taper inward toward each other from opposite ends of the collar to form a reduced diameter portion at or near an axial center of the casing collar. It should be understood that a preferred method is for the casing segments 50 to arrive at the rig site 11 with a casing collar 48 installed on one end forming a box end 55 of the casing segment.

When adjacent casing segments 54 are threaded into opposite ends of the casing collar 48, they can be threaded toward each other in the casing collar and may reach a desired torque position for the tool joint before abutting each other within the casing collar. The torque position can be determined by a “diamond mark” on the pin end 57 of the casing segment 50 just above the threads of the pin end 57. To make up a casing joint, the pin end 57 of the casing segment 50 is threaded into the casing collar 48 until the shoulder of the casing collar 48 is substantially axially aligned with the diamond mark on the casing segment. This can indicate that, per API standards, that the threads of the casing segment 50 provide sufficient engagement with the threads of the casing collar 48. The casing joint can be referred to as a buttress connection. When a buttress connection is made up without using a torque ring, the diamond mark is used to verify that the buttress connection is made up correctly. When a buttress connection is made up using a torque ring, then additional torque can be applied to the connection without causing yielding of the pin in the coupling while the “diamond mark” is still the determining factor as to whether the connection has been made up properly per API standards.

The gap can be calculated based on the thread taper of each of the adjacent casing segments and a position of the diamond mark which can indicate that the pin end 57 of the casing segment 50 is sufficiently threaded into the casing collar 48. This gap can be filled with a torque ring that can fill the pre-determined gap length (or distance) and abut the end shoulders of the adjacent casing segments when the tool joint is torqued to the pre-determined torque value (such as via a casing tong, a casing running tool, or possibly an iron roughneck 40 if it were configured to handle the diameters of the casing segments 50).

The gap may vary between various casing joints (various diameters, thread pitches, manufacturing tolerances, etc.). Therefore, the operators (or automated handlers) can select and install the torque ring with the correct axial length to fill the gap and allow the adjacent casing segments to thread the desired distance into the casing collar before abutting the torque ring. This selection can take valuable operator time (or automated handler time) during running the casing string into the wellbore 15. The installation of torque rings can be performed while the casing segments 50, with pre-installed casing collars 48 on a box end 55, are positioned in the horizontal storage area 38. The operators (or automated handlers) can pre-install a torque ring in each casing collar 48 on each casing segment before the casing segment 50 is transported to the rig floor 16 by a catwalk 20 or a pipe handler 32.

The inventors of the current torque ring selection method and system have devised a novel method and system to aid in the selection of the correct torque ring. In general, the novel method and system provides an improved determination of the gap distance for the current tool joint by detecting a selection distance and selecting the desired torque ring that corresponds to the selection distance.

Even though it may not be done very often, the casing string 58 can be tripped out of the wellbore 15. For tripping out, the casing string 58 is run out of the wellbore 15 by successively removing casing segments 54 from the top end of the casing string 58 to further retract the casing string 58 from the wellbore 15. The casing segments 54 removed from the casing string 58 can be moved away from the well center 24 and stored in a horizontal tubular storage area 38 or vertical tubular storage area 80 or removed from the rig site 11. It should be understood that any other tubular manipulation systems can be used to remove casing segments from well center 24 and move the casing segments to a horizontal tubular storage area 38 or vertical tubular storage area 80.

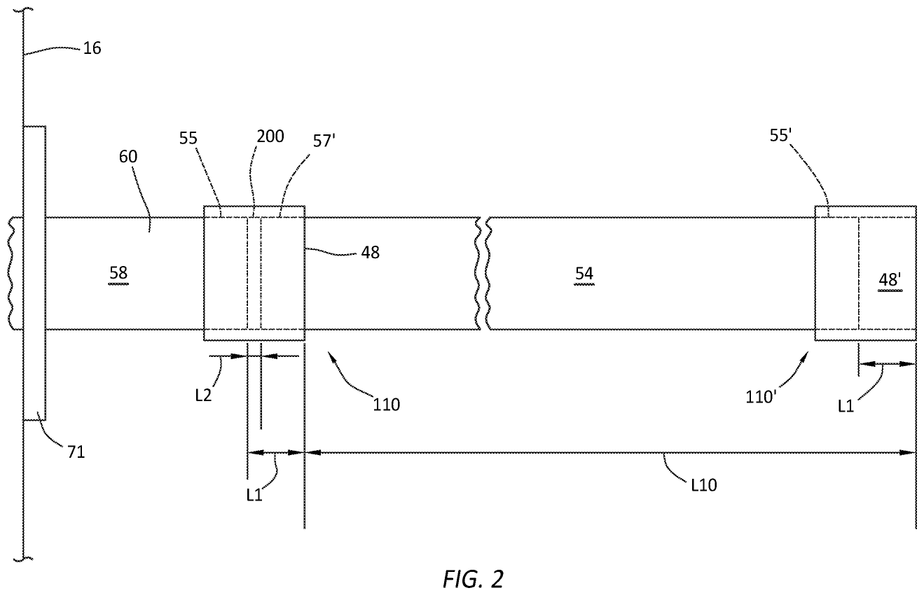

In the case of running casing segments 54 into or out of the wellbore 15, casing segments 54 may be coupled together via a casing collar 48 (or coupling 48, see FIG. 2). The casing segment 54 may have both ends threaded with tapered external threads so ends of adjacent casing segments 54 are threaded into the casing collar 48 from opposite ends. The casing collar 48 can have internal threads that engage the external threads of two adjacent casing segments 54. When running casing segments 54 into the wellbore 15, the top end of the casing string 58 can have a casing collar 48 threaded onto the top end forming a box end 55 of the casing string 58. The next casing segment 54 can be aligned with the casing string 58 and threaded into the casing collar 48 forming the box end of the casing string 58. When the casing joint is threaded to the diamond mark to meet API requirements, a gap may exist between the top end of the casing string 58 and the newly added casing segment 54. Therefore, a known length L10 of the casing segment 54 can include the overall length of the casing segment 54 measured from each longitudinal end (also referred to as a shoulder) of the casing segment 54 plus the gap between the casing string 58 and the newly added casing segment 54. The gap can be filled by a torque ring that can be used to provide increased strength of the made-up casing joint. This known length L10 is added or subtracted as needed to update a pipe tally length as the casing string 58 is tripped out of or into the wellbore 15.

FIG. 1 shows a casing segment 54 that has been moved from the horizontal storage area 38 (i.e., casing segment 50), up the catwalk 20 (i.e., casing segment 52), and to a vertically oriented location at well center 24. The casing segment 54 has been coupled to the casing running tool 100 at its box end 55 and the pin end 57 of the casing segment 54 has been connected to the box end 55 of the casing string 58. The casing running tool 100 can include a link pair 102 rotationally coupled to the casing running tool 100 at one end and coupled to an elevator clamp 104 at an opposite end. It should be understood that the link pair 102 can be rotationally coupled to the top drive 18 when the casing running tool 100 is not used. The elevator clamp 104 can be used to clamp around a casing segment 52 and lift the casing segment 52 to a vertical orientation as the top drive 18 is raised by the crown block 29.

A rig controller 150 can include one or more processing units communicatively coupled, via a network 154 to the top drive 18 and casing running tool 100 (or elevator attached to the top drive). One or more of the processing units can be local to or remotely located from either or both of the top drive 18 and casing running tool 100 (or elevator attached to the top drive). The rig controller 150 can be communicatively coupled to the sensors 70 for collecting sensor data or imagery of casing segments 50, 52, 54, casing string 58, tool joints 110, or rig equipment supporting the subterranean operations of the rig 10. At least one sensor 70 on the top drive 18 can be used to measure, detect, or determine the vertical height of the top drive 18 above the rig floor 16. The tubular management system can coordinate retrieval of casing segments 54 from or delivery of casing segments 54 to the vertical tubular storage area 80 or horizontal storage area 38.

FIG. 2 is a representative side view of a portion of a casing string 58 extending above slips 71 on a rig floor 16 with a casing segment 54 newly added to the casing string 58. The newly added casing segment 54 has been threaded into the casing collar 48 and torqued via a torque wrench (e.g., a power tong, a casing running tool, or possibly an iron roughneck) to make up the tool joint 110. A torque ring 200 can be installed in the casing collar 48 prior to threadably connecting the casing segment 54. The torque ring 200 can be manually installed in the casing collar 48 by threadably engaging the external threads of the torque ring 200 with the internal threads of the casing collar 48 and threading the torque ring 200 into engagement with the top shoulder of the casing string 58. The engagement of the threads of the torque ring 200 with the casing collar 48 can hold the torque ring 200 in position in the casing collar 48 while waiting for the casing segment 54 to be threadably coupled to the casing collar 48. When the tool joint 110 is torqued to a desired torque, the torque ring 200 can be held in compression between the shoulder of the pin end 57′ of the casing segment 54 and the shoulder of the box end 55 of the casing string 58. A casing collar 48′ can be installed on the casing segment 54 before or after coupling the casing segment 54 to the casing string 58. The distance L1 is a distance that can be used to determine which one of a plurality of torque rings 200 is a desired torque ring 200 for making up the tool joint 110, 110′.

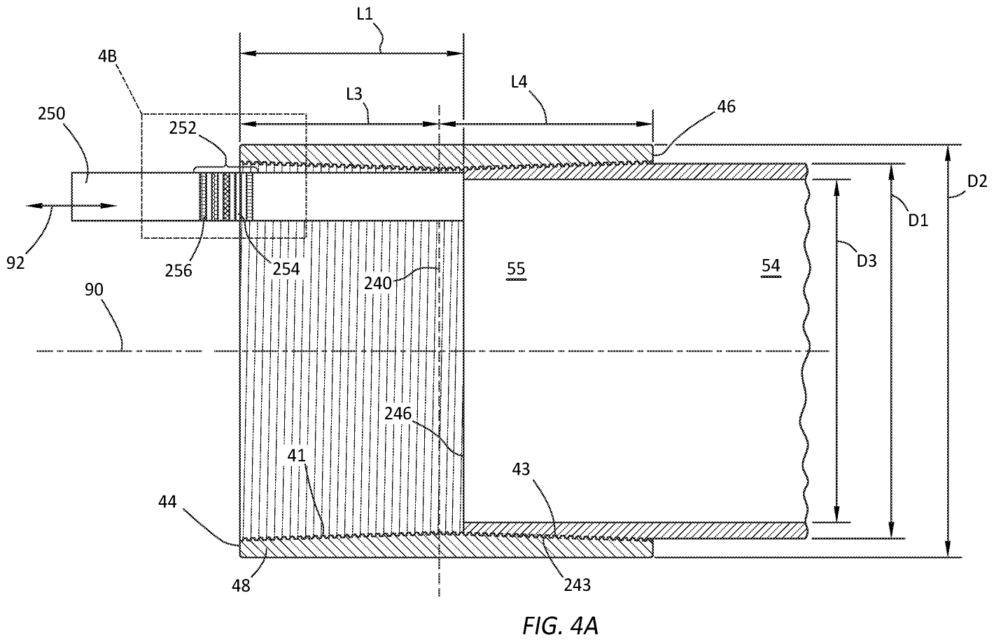

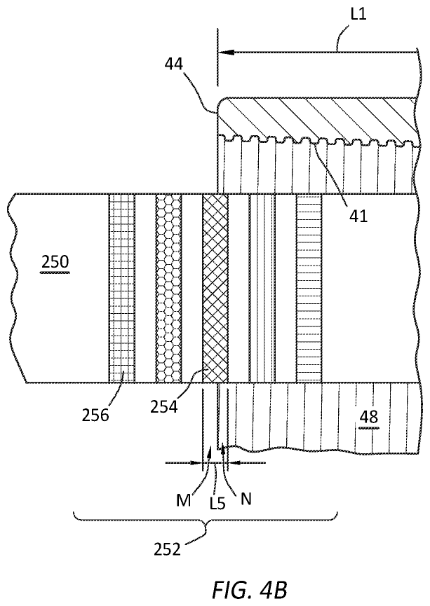

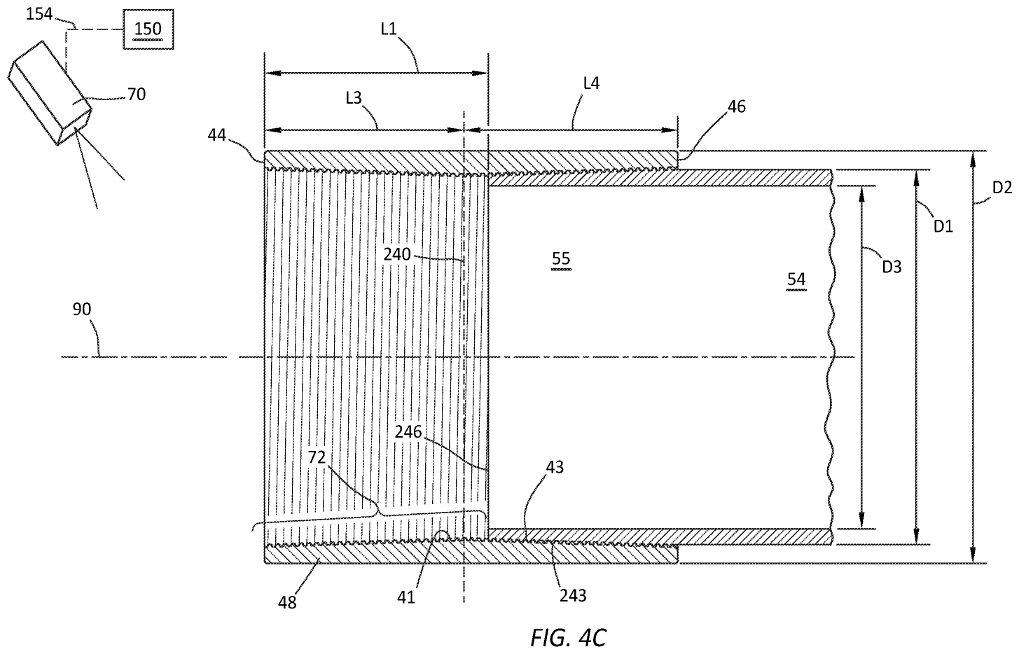

The casing segment 54 can include external threads on the box end 55′ and pin end 57′, with a casing collar 48′ being threaded onto the threads of the box end 55′. The external threads on the pin end 57′ of the casing segment 54 can be threaded into a casing collar 48 which can result in a gap L2 between the box end 55 of the casing string 58 and the pin end 57′, which is threaded into an opposite end of the casing collar 48. The known length L10 can represent the distance between a top shoulder of the casing collar 48′ and the top shoulder of the casing collar 48. The following description regarding FIGS. 4A-6B describe methods and systems for making up a casing string 58 tool joint 110 using a torque ring 200 installed in a casing collar 48 between two casing segments 54 (where one of the casing segments 54 can be the top most casing segment in the casing string 58).

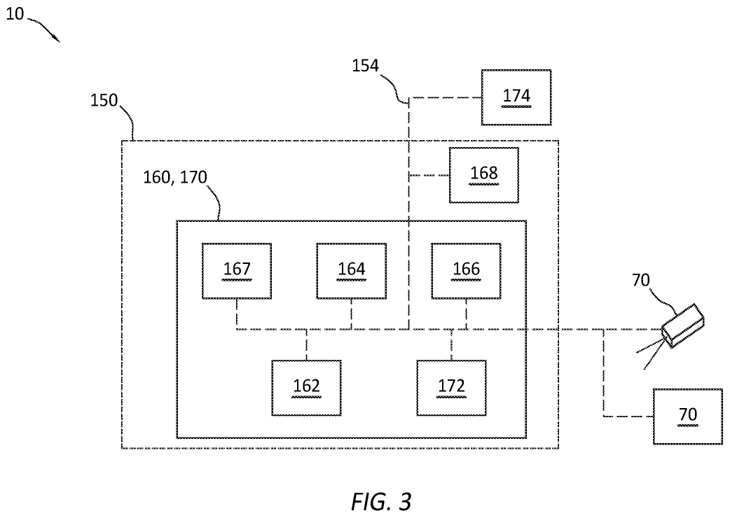

Referring to FIG. 3, the rig 10 can include a rig controller 150 with one or more local processing units 160 that can be locally positioned with either or both the top drive 18 and casing running tool 100 or one or more remote processing units 170. However, both of the processing units 160, 170 can be remotely positioned from either or both the top drive 18 and casing running tool 100. Each processing unit 160, 170 can include one or more processors 162, 172 (e.g., microprocessors, programmable logic arrays, programmable logic devices, etc.), non-transitory memory storage 164, peripheral interface 166, human machine interface (HMI) device(s) 168, and possibly a remote telemetry interface 174 for internet communication or satellite network communication. The HMI devices 168 can include a touchscreen, a laptop, a desktop computer, a workstation, or wearables (e.g., smart phone, tablet, etc.). These components of the rig controller 150 can be communicatively coupled together via one or more networks 154, which can be wired or wireless networks.

The processors 162, 172 can be configured to read instructions from one or more non-transitory memory storage devices 164 and execute those instructions to perform any of the operations described in this disclosure. The processing units 160, 170 can also include one or more databases 167 that can store data from the sensors 70.

A peripheral interface 166 can be used by the rig controller 150 to receive sensor data from around the rig such as from the sensors 70, such as two dimensional (2D) cameras, three dimensional (3D) cameras, infrared cameras, closed circuit television (CCTV) cameras, X-ray sensors, light detection and ranging (LiDAR) sensors, proximity sensors, strain gauges, torque sensors, accelerometers, optical sensors, laser sensors, physical contact sensors, contact sensors with encoders, audio sensors, pressure sensors, temperature sensors, environmental sensors, gas sensors, liquid sensors, or other suitable sensors for detecting characteristics of the rig environment or tubulars, which can collect data on various equipment at the rig site 11, such as a power tong, the pipe handlers 32, the catwalk 20, the top drive 18, casing running tool 100, casing segments 50, 52, 54, etc. The peripheral interface 166 can also be used by the rig controller 150 to send commands to the power tong or iron roughneck 40, the pipe handlers 32, the catwalk 20, the top drive 18, casing running tool 100, etc. to perform subterranean operations such as tripping in the casing string 58 into the wellbore 15. The peripheral interface 166 can also be configured to communicate with one or more sensors 70, which can be used to capture images of casing segments 50 or perform light ranging (such as with LiDAR or time-of-flight cameras) and transfer the images or the ranging data to the processing units for determining (or verifying) characteristic(s) of the tubulars, such as length, diameters, tool joint lengths, thread length, actual location, actual orientation, etc.

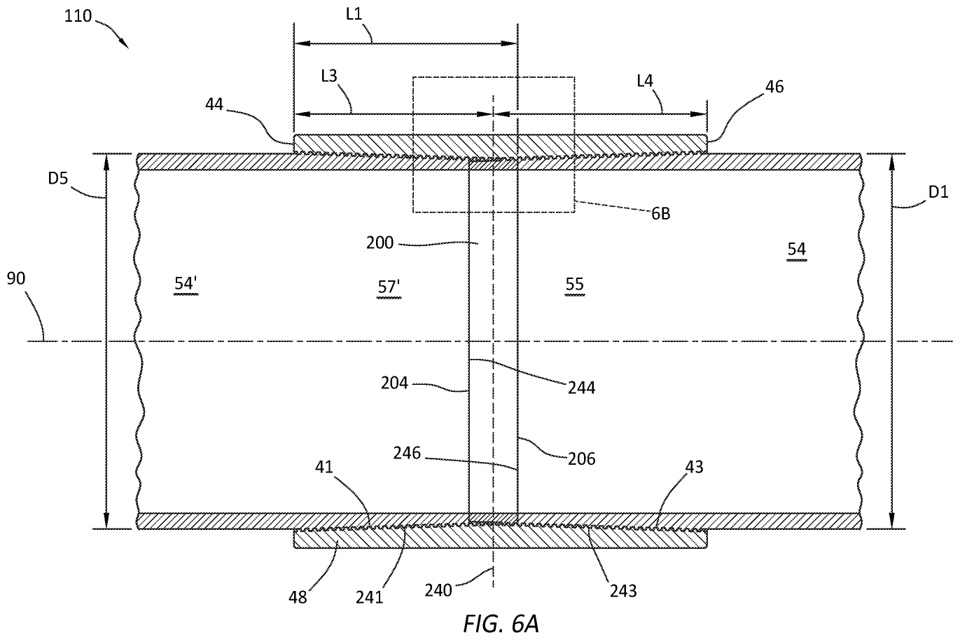

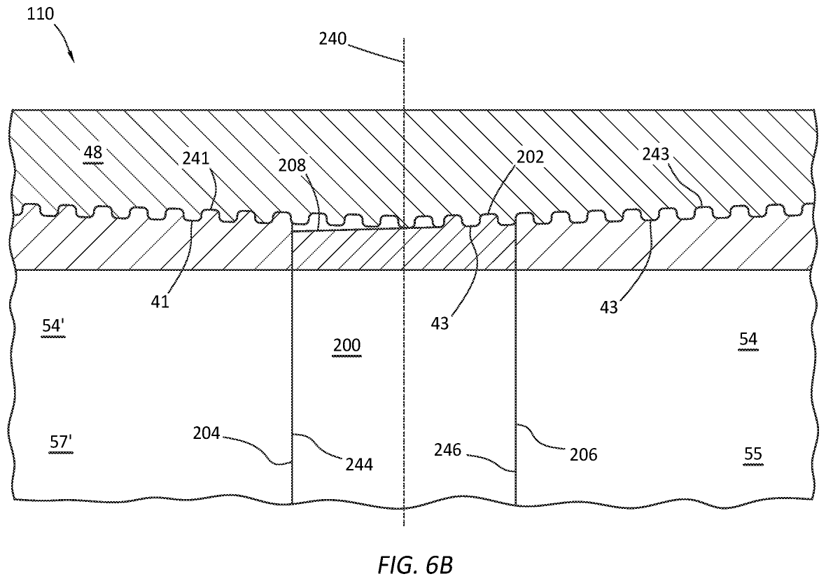

FIG. 4A is a representative partial cross-sectional view of a casing collar 48 attached to a casing segment 54 with a selection guide 250 that can be used to determine a desired torque ring 200 from a plurality of torque rings for making up the tool joint 110. The collar 48 can have an axial center 240 that is substantially perpendicular to the longitudinal axis 90. Therefore, the lengths L3, L4 are generally equal to each other. However, it is not a requirement that the length L3 is substantially equal to the length L4. The casing collar 48 can include a shoulder 44 at one end and a shoulder 46 at an opposite end as well as two sets of tapered internal threads 41, 43. The tapered internal threads 41 can taper radially inward from the shoulder 44 to the axial center 240 to match the tapered external threads 241 of a casing segment 54′ (see FIG. 6A). The tapered internal threads 43 can taper radially inward from the shoulder 44 to the axial center 240 to match the tapered external threads 243 of a casing segment 54.

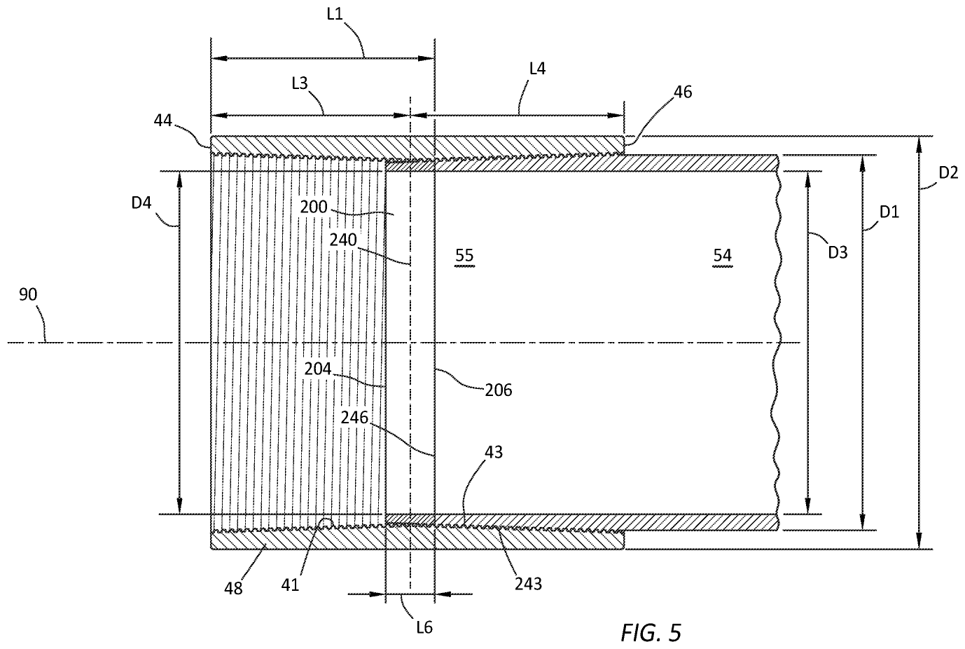

The outer diameter D1 of the casing segments 54, 54′ generally determines the outer diameter D2 of the casing collar 48. An inner diameter D3 of the casing segments 54, 54′ can determine the inner diameter D4 of the torque ring 200, since it may be desirable that the inner diameter D4 of the torque ring 200 (see FIG. 5) be substantially equal to the inner diameter D3.

After the casing collar 48 has been installed onto the casing segment 54, yet before the casing segment 54′ is installed in the opposite end of the casing collar 48, the distance L1 can be used to determine a length L6 (see FIG. 5) of the torque ring 200 by inserting (arrows 92) a selection guide 250 into the opposite end (past shoulder 44) of the casing collar 48 as shown and abutting one end of the selection guide 250 against the shoulder 246 of the casing segment 54, with the other end of the selection guide 250 protruding from the opposite end (i.e., shoulder 44) of the collar 48. The selection guide 250 can include a plurality of length indicators 252, where each indicator can represent a range of lengths for the length L1. If the length L1 falls within the length range of the indicator 254 (as shown), the length of the torque ring 200 can be determined by selecting the length L6 (see FIG. 5) of the torque ring 200 that corresponds to the indicator 254. As a way of a non-limiting example, the length range for each indicator 254 can represent approximately 0.16 inches +/−0.01 inches of length deviation for length L1. The selection guide 250 is described in more detail below regarding FIG. 4B, which is a detailed view of the region 4B in FIG. 4A.

FIG. 4B is a representative detailed partial cross-sectional view of the region 4B indicated in FIG. 4A. When the selection guide 250 is inserted into the casing collar 48 and into engagement with the shoulder 246, the length L1 causes the shoulder 44 to be positioned within one of the length ranges of the plurality of length indicators 252. Each of the plurality of length indicators 252 can have a length L5 associated with it, so when the selection guide 250 indicates in which one of the plurality of length indicators 252 the shoulder 44 is positioned, then the associated length L6 for that length indicator (e.g., indicator 254) can be used to select the desired torque ring 200 to be installed in the casing collar 48. The length L5 indicates a range of lengths for length L1 that would cause a length L6 to be chosen for the torque ring 200. As way of a non-limiting example, the length L1 can range from 5 inches to 6.5 inches. The number of length indicators 252 can be selected to cover the length range of L1.

Alternatively, if the shoulder 44 is positioned within the length range indicated by the indicator 256 (i.e., length L1 within the indicated range), then the length L6, associated with the indicator 256, can be chosen for the torque ring 200. The length L5 of indicator 254 can be seen as being a length range from (L1+M) to (L1−N). As a way of a non-limiting example, the length L5 can represent approximately 0.16 inches +/−0.01 inches of length deviation for length L1.

An operator can insert the selection guide 250 into the casing collar 48, engage the shoulder 246 of the casing segment 54, and determine the desired length L6 of the torque ring 200 by determining within which of the plurality of length indicators 252 the shoulder 44 is positioned (or to which it is adjacent). With the desired length L6 determined, the operator can then manually thread the desired torque ring 200 into the casing collar 48 into engagement with the shoulder 246.

Alternatively, or in addition to, a sensor 70 can be used by a rig controller 150 to determine the desired length L6 for the torque ring 200 to be installed in the casing collar 48. FIG. 4C is a representative partial cross-sectional view of a casing collar 48 attached to a casing segment 54 with one or more sensors 70 configured to determine a desired torque ring 200 for making the tool joint 110. The one or more sensors 70 (and casing collar 48) should be positioned in such a way that the one or more sensors 70 have the region 72 in their field of interest. Therefore, when the one or more sensors 70 collect sensor data, the sensor data will include the region 72, which includes at least a portion of the shoulder 44, a portion of the threads 41, and a portion of the shoulder 246 of the casing segment 54. The sensor data can be processed by the rig controller 150 to determine the length L1.

The sensors 70 can be at least one of a 2D camera, a 3D camera, an infrared camera, a CCTV camera, an X-ray sensor, a LiDAR sensor, a proximity sensor, a strain gauge, a torque sensor, an accelerometer, an optical sensor, a laser sensor, a physical contact sensor, a contact sensor with an encoder, an audio sensor, other suitable sensors for detecting the length L1, or combinations thereof. The rig controller 150 can perform image processing on imagery collected from the sensors 70 to determine the length L1. The rig controller 150 can also perform ranging processing on ranging data collected from ranging sensors 70 (e.g., LiDAR sensors, time-of-flight sensors, etc.) to determine the length L1.

FIG. 5 is a representative partial cross-sectional view of a casing collar 48 attached to a casing segment 54 with a desired torque ring 200 installed in the casing collar 48. After the length L6 of the torque ring 200 is determined, then the operator can manually thread the desired torque ring 200 into the casing collar 48 and engage the shoulder 206 of the desired torque ring 200 with the shoulder 246 of the casing segment 54.

FIG. 6A is a representative partial cross-sectional view of a casing collar 48 attached to a casing segment 54 with a desired torque ring 200 (of length L6) installed in the casing collar 48 and a second casing segment 54′ installed in an opposite end (i.e., the shoulder 44) of the casing collar 48 and abutting the shoulder 204 of the torque ring 200 with the shoulder 244 of the casing segment 54′. The tapered internal threads 41 of the casing collar 48 can be threadably engaged with the tapered external threads 241 of the pin end 57′ of the casing segment 54′. The outer diameter D5 of the casing segment 54′ can be substantially equal to the outer diameter D1 of the casing segment 54. The tool joint 110 can be torqued to a desired torque value, thereby making up the tool joint 110, which can also be indicated by the diamond mark.

FIG. 6B is a representative detailed partial cross-sectional view of the region 6B indicated in FIG. 6A. As can be seen, the threads 241 of the casing segment 54′ are engaged with the threads 41 of the casing collar 48, the threads 243 of the casing segment 54 are engaged with the threads 43 of the casing collar 48, the external threads 202 of the torque ring 200 are engaged with a portion of the internal threads 43 of the casing collar 48, the shoulder 244 of the casing segment 54′ is engaged with the shoulder 204 of the torque ring 200, and the shoulder 246 of the casing segment 54 is engaged with the shoulder 206 of the torque ring 200. When the tool joint 110 is torqued to the desired torque value, the torque ring 200 can be compressed between the casing segments 54, 54′. The torque ring 200 provides a more robust tool joint 110 that can withstand higher bending moments and higher make-up torques than a tool joint without the torque ring 200.

The tapered surface 208 of the torque ring 200 can be smooth and provide minimal (if any) engagement with internal threads of the casing collar 48. However, it should be understood that the surface 208 can also include a rough surface texture or a set of annular grooves with annular peaks between the annular grooves, where the annular peaks provide a friction engagement with the internal threads of the casing collar 48 to help retain the torque ring 200 installed in the casing collar 48 before the second casing segment 54′ is installed in the casing collar 48.

### VARIOUS EMBODIMENTS

Embodiment 1. A method for extending a casing string in a wellbore, the method comprising:
securing the casing string in slips on a rig floor, wherein the casing string is at least partially extended into the wellbore through the slips and at least a portion of the casing string extends above the rig floor to form a stump of the casing string, wherein the casing string comprises a first casing collar that forms a box end of the casing string at the stump, and wherein a first torque ring is installed in the first casing collar;
selecting a first casing segment in a horizontal storage area, wherein the first casing segment comprises a second casing collar installed onto an end of the first casing segment to form a box end of the first casing segment, with an opposite end of the first casing segment being a pin end of the first casing segment;
determining a selection distance, wherein the selection distance is measured between a first shoulder of the first casing segment and a second shoulder of the second casing collar, wherein the first shoulder is proximate the box end of the first casing segment and the second shoulder is disposed on an opposite end of the second casing collar from a third shoulder of the second casing collar; and selecting a second torque ring based on the selection distance.

Embodiment 2. The method of embodiment 1, further comprising installing the second torque ring in the second casing collar and abutting the first shoulder of the first casing segment with the second torque ring.

Embodiment 3. The method of embodiment 2, further comprising:
delivering the first casing segment to the rig floor;
torquing the pin end of the first casing segment into the first casing collar on the stump;
delivering a second casing segment to the rig floor,
threading a pin end of the second casing segment into the second casing collar;
torquing the pin end of the second casing segment into the box end of the first casing segment; and
compressing the second torque ring between the pin end of the second casing segment and the first shoulder of the first casing segment.

Embodiment 4. The method of embodiment 2, wherein installing the second torque ring comprises manually threading the second torque ring into the second casing collar.

Embodiment 5. The method of embodiment 1, wherein selecting the second torque ring comprises selecting the second torque ring from a plurality of torque rings, with each of the plurality of torque rings each having a predetermined length.

Embodiment 6. The method of embodiment 5, wherein the plurality of torque rings comprises at least one torque ring that has a different predetermined length than another one or more torque rings of the plurality of torque rings.

Embodiment 7. The method of embodiment 6, wherein the second torque ring is selected based on the predetermined length of the second torque ring which correlates to the selection distance.

Embodiment 8. The method of embodiment 1, wherein selecting the second torque ring comprises selecting one of a plurality of torque rings based on the selection distance, wherein a length of the one of the plurality of torque rings is different than at least another one of the plurality of torque rings, and wherein the length of the one of the plurality of torque rings is measured in parallel to a center longitudinal axis of the one of the plurality of torque rings.

Embodiment 9. The method of embodiment 8, wherein a first diameter of the first casing segment determines a second diameter of the second torque ring.

Embodiment 10. The method of embodiment 8, wherein a first diameter of the first casing collar determines a second diameter of the second torque ring.

Embodiment 11. The method of embodiment 1, further comprising:
collecting imagery, via one or more imaging sensors, that contains a portion of internal threads of the second casing collar, the first shoulder of the first casing segment, and the second shoulder of the second casing collar; and
determining, via a rig controller, the selection distance by performing image processing on the imagery.

Embodiment 12. The method of embodiment 11, wherein the one or more imaging sensors comprise one or more of a 2D camera, a 3D camera, a CCTV camera, a video recorder, and a handheld image recording device.

Embodiment 13. The method of embodiment 1, further comprising:
collecting ranging data, via one or more ranging sensors, of the first shoulder of the first casing segment and the second shoulder of the second casing collar; and
determining, via a rig controller, the selection distance by processing the ranging data.

Embodiment 14. The method of embodiment 13, wherein the one or more ranging sensors comprise one or more time-of-flight cameras.

Embodiment 15. The method of embodiment 14, wherein the one or more time-of-flight cameras are a light detection and ranging (LiDAR) camera.

Embodiment 16. The method of embodiment 1, wherein selecting the first torque ring further comprises using a selector guide that indicates a torque ring color based on the selection distance, and wherein the first torque ring is selected based on the torque ring color indicated by the selection guide.

Embodiment 17. A method for making up a tool joint in a casing string, the method comprising:
receiving a first casing segment at a rig, wherein the first casing segment comprises a first casing collar installed to an end of the first casing segment thereby forming a box end of the first casing segment;
determining a selection distance, wherein the selection distance is measured between a first shoulder of the first casing segment and a second shoulder of the first casing collar, wherein the first shoulder is proximate the box end of the first casing segment and the second shoulder is disposed on an opposite end of the first casing collar from a third shoulder of the first casing collar; and
selecting a first torque ring based on the selection distance.

Embodiment 18. The method of embodiment 17, further comprising installing the first torque ring in the first casing collar and abutting the first shoulder of the first casing segment with the first torque ring.

Embodiment 19. The method of embodiment 18, further comprising:
threading a pin end of a second casing segment into the first casing collar;
torquing the pin end of the second casing segment into the box end of the first casing segment; and
compressing the first torque ring between the pin end of the second casing segment and the first shoulder of the first casing segment.

Embodiment 20. The method of embodiment 18, wherein installing the first torque ring comprises manually threading the first torque ring into the first casing collar.

Embodiment 21. The method of embodiment 17, wherein selecting the first torque ring comprises selecting the first torque ring from a plurality of torque rings, with each of the plurality of torque rings each having a pre-determined length.

Embodiment 22. The method of embodiment 21, wherein the plurality of torque rings comprises at least one torque ring that has a different pre-determined length than another one or more torque rings of the plurality of torque rings.

Embodiment 23. The method of embodiment 22, wherein the first torque ring is selected based on the pre-determined length of the first torque ring which correlates to the selection distance.

Embodiment 24. The method of embodiment 17, wherein selecting the first torque ring comprises selecting one of a plurality of torque rings based on the selection distance, wherein a length of the one of the plurality of torque rings is different than at least another one of the plurality of torque rings, and wherein the length of the one of the plurality of torque rings is measured in parallel to a center longitudinal axis of the one of the plurality of torque rings.

Embodiment 25. The method of embodiment 24, wherein a first diameter of the first casing segment determines a second diameter of the first torque ring.

Embodiment 26. The method of embodiment 24, wherein a first diameter of the first casing collar determines a second diameter of the first torque ring.

Embodiment 27. The method of embodiment 17, further comprising:
collecting imagery, via one or more imaging sensors, that contains a portion of internal threads of the first casing collar, the first shoulder of the first casing segment, and the second shoulder of the first casing collar; and
determining, via a rig controller, the selection distance by performing image processing on the imagery.

Embodiment 28. The method of embodiment 27, wherein the one or more imaging sensors comprise one or more of a 2D camera, a 3D camera, a CCTV camera, a video recorder, and a handheld image recording device.

Embodiment 29. The method of embodiment 17, further comprising:
collecting ranging data, via one or more ranging sensors, of the first shoulder of the first casing segment and the second shoulder of the first casing collar; and
determining, via a rig controller, the selection distance by processing the ranging data.

Embodiment 30. The method of embodiment 29, wherein the one or more ranging sensors comprise one or more time-of-flight cameras.

Embodiment 31. The method of embodiment 30, wherein the one or more time-of-flight cameras are a light detection and ranging (LiDAR) camera.

Embodiment 32. The method of embodiment 17, wherein selecting the first torque ring further comprises using a selector guide that indicates a torque ring color based on the selection distance, and wherein the first torque ring is selected based on the torque ring color indicated by the selection guide.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

What is claimed is:

1. A method for building a casing string, the method comprising:
installing a first casing collar on a first end of a first casing segment;
determining a first selection distance, wherein the first selection distance is measured between a shoulder of the first end of the first casing segment and a shoulder of the first casing collar; and
selecting a first torque ring based on the first selection distance.

2. The method of claim 1, further comprising installing the first torque ring in the first casing collar.

3. The method of claim 2, wherein installing the first torque ring comprises manually threading the first torque ring into the first casing collar.

4. The method of claim 2, further comprising:
installing a first end of a second casing segment in an opposite end of the first casing collar from the first casing segment;
abutting a first shoulder of the first casing segment with the first torque ring to form a first casing joint; and
torquing the first casing joint to make-up the first casing joint, thereby longitudinally compressing the first torque ring between the first casing segment and the second casing segment.

5. The method of claim 4, further comprising:
installing a second casing collar on a second end of the second casing segment;
determining a second selection distance, wherein the second selection distance is measured between a shoulder of the second end of the second casing segment and a shoulder of the second casing collar; and
selecting a second torque ring based on the second selection distance.

6. The method of claim 5, further comprising installing the second torque ring in the second casing collar.

7. The method of claim 6, further comprising:
installing a first end of a third casing segment in an opposite end of the second casing collar from the second casing segment;
abutting a first shoulder of the second casing segment with the second torque ring to form a second casing joint; and
torquing the second casing joint to make-up the second casing joint, thereby longitudinally compressing the second torque ring between the second casing segment and the third casing segment.

8. The method of claim 1, wherein selecting the first torque ring comprises selecting the first torque ring from a plurality of torque rings, with each of the plurality of torque rings having a predetermined longitudinal length.

9. The method of claim 8, wherein the plurality of torque rings comprises at least one torque ring that has a different predetermined longitudinal length than another one or more torque rings of the plurality of torque rings.

10. The method of claim 9, wherein the first torque ring is selected based on the predetermined longitudinal length of one of the plurality of torque rings which correlates to the first selection distance.

11. The method of claim 1, wherein selecting the first torque ring comprises selecting one of a plurality of torque rings based on the first selection distance, wherein a longitudinal length of the one of the plurality of torque rings is different than at least another one of the plurality of torque rings, and wherein the longitudinal length of the one of the plurality of torque rings is measured in parallel to a center longitudinal axis of the one of the plurality of torque rings.

12. The method of claim 1, further comprising:
collecting imagery, via one or more imaging sensors, that contains a portion of internal threads of the first casing collar, the shoulder of the first end of the first casing segment, and the shoulder of the first casing collar; and
determining, via a rig controller, the first selection distance by performing image processing on the imagery.

13. The method of claim 12, wherein the one or more imaging sensors comprise one or more of a 2D camera, a 3D camera, a CCTV camera, a video recorder, and a handheld image recording device.

14. The method of claim 1, further comprising:
collecting ranging data, via one or more ranging sensors, between the shoulder of the first end of the first casing segment and the shoulder of the first casing collar; and
determining, via a rig controller, the first selection distance by performing data processing of the ranging data.

15. The method of claim 14, wherein the one or more ranging sensors comprise one or more time-of-flight cameras.

16. The method of claim 15, wherein the one or more time-of-flight cameras are a light detection and ranging (LiDAR) camera.

17. The method of claim 1, wherein selecting the first torque ring further comprises using a selector guide that indicates a torque ring color based on the first selection distance, and wherein the first torque ring is selected based on the torque ring color indicated by the selection guide.

18. A method for making up a tool joint in a casing string, the method comprising:
receiving a first casing segment at a rig, wherein the first casing segment comprises a first casing collar installed to an end of the first casing segment thereby forming a box end of the first casing segment;
determining a selection distance, wherein the selection distance is measured between a first shoulder of the first casing segment and a first shoulder of the first casing collar, wherein the first shoulder of the first casing segment is proximate the box end of the first casing segment and the first shoulder of the first casing collar is disposed on an opposite end of the first casing collar from a second shoulder of the first casing collar; and
selecting a first torque ring based on the selection distance.

19. The method of claim 18, further comprising installing the first torque ring in the first casing collar and abutting the first shoulder of the first casing segment with the first torque ring.

20. The method of claim 19, further comprising:
threading a pin end of a second casing segment into the first casing collar;
torquing the pin end of the second casing segment into the box end of the first casing segment; and
compressing the first torque ring between the pin end of the second casing segment and the first shoulder of the first casing segment, thereby making up a tool joint in a casing string.
